(19) United States
(12) Patent Application Publication
(10) Pub. No.: US 2024/0211988 A1
(43) Pub. Date: Jun. 27, 2024

(54) Collaborative marketplace, pricing, revenue optimization, and rewards platform for digital subscription brands

(71) Applicant: Richard Annichiarico, Croton on Hudson, NY (US)

(72) Inventor: Richard Annichiarico, Croton on Hudson, NY (US)

(21) Appl. No.: 18/396,406

(22) Filed: Dec. 26, 2023

Related U.S. Application Data
(60) Provisional application No. 63/435,523, filed on Dec. 27, 2022.

(51) Int. Cl. G06Q 30/0207; G06Q 30/0251

(52) U.S. Cl. CPC G06Q 30/0236; G06Q 30/0213; G06Q 30/0222; G06Q 30/0239; G06Q 30/0271

(57) ABSTRACT

The invention discloses a groundbreaking collaborative subscription marketplace and loyalty platform, uniting diverse brands in a personalized hub. Its dynamic pricing tailor's subscription offers based on individual consumer spending. This not only maximizes brand revenues but also offers consumers personalized pricing linked to an existing subscription. An intelligent system analyzes subscriber behavior, providing personalized discounts from collaborating brands. This fosters subscriber loyalty by linking discounts to an existing subscription, building trust and brand value. Pricing optimization empowers brands to set personalized prices and target specific audience segments. Its agility allows real-time adjustments, ensuring brands adapt to market dynamics. The platform facilitates seamless collaboration, enabling cross-promotion without complex contracts; Opens new markets for brands, promoting alongside popular local brands for global distribution; Places the power of marketing, distribution, loyalty, and pricing optimization directly in the hands of subscription brands and introduces collaboration as the cornerstone for growth, subscriber satisfaction, and profitability.

### CROSS-REFERENCE TO RELATED APPLICATION

This application claims the benefit of U.S. Provisional application No. 63/435,523 filed Dec. 27, 2022, which is incorporated by reference herein in its entirety.

### BACKGROUND OF THE INVENTION

The present invention addresses the challenges faced by digital subscription brands operating in a highly competitive market. With the proliferation of subscription services ranging from news and TV to music, dating, education, games, wellness, and more, acquiring and retaining subscribers while achieving profitability has become increasingly difficult. This invention is focused on transforming the digital subscription landscape by providing subscription brands with a collaborative platform to overcome obstacles in marketing, distribution, retention, and pricing optimization.

Current solutions for subscription service providers are expensive and encourage consumers to jump from one service to another rather than add additional services at prices that make sense. Existing retention methods are equally expensive and seek only to retain members by offering rewards from the same provider. No solutions exist that encourage collaboration as a solution to lower acquisition costs, increase retention, optimize pricing & revenue strategies, and improve profit margins.

Marketing and Distribution: It is standard practice for subscription brands to pay exorbitant amounts of money, either upfront or as a percentage of the consumers payment to get their brand marketed on third party platforms where they can reach millions of consumers.

Retention: Similarly, retention costs are expensive and provide little if any actual retention boosts as rewards are not sticky enough to keep consumer's from canceling long term.

Pricing optimization remains a major challenge, with brands forced to adopt a one-size-fits-all approach, either pricing too high for some or below the perceived value for others. There's a growing need for brands to offer services based on individual consumer spending behaviors, providing incentives for subscribers to add services to their existing portfolio.

Revenue optimization and cross-promotions are sought after, but the current methods involve intricate contract negotiations, inflexible pricing, and additional marketing costs for bundling services. The power to control marketing, distribution, loyalty, and pricing optimization is yet to be placed firmly in the hands of subscription brands.

The invention introduces a collaborative subscription marketplace and loyalty platform that empowers digital subscription brands. The invention aims to revolutionize the industry by providing brands with a dedicated space to collaborate, personalize pricing, optimize subscriber retention, and streamline marketing and distribution efforts.

### BRIEF SUMMARY

This application encompasses the innovation of a revolutionary collaborative subscription marketplace and loyalty platform, designed as an industry-first. It introduces a cohesive ecosystem where subscription brands converge to leverage collective resources for strategic marketing and distribution, subscriber retention through loyalty rewards, cost reduction, personalized pricing based on subscribers' existing subscriptions, and comprehensive subscription management tools.

### High Level Overview:

The platform empowers each subscribing brand to establish its dedicated, white-labeled web or app-based marketing and distribution hub. Within this hub, brands offer their subscribers personalized access to exclusive offers from other subscription brands.

Retention: Other brands' offers dynamically appear to subscribers based on how much each subscriber is already spending on other services. By offering subscribers access to personalized discounts from other services, brands can better retain their own subscribers because those discounts are contingent on remaining active subscribers of that original brand. In addition, brands that offer their subscribers access to these discounted offers can build trust, increase brand value, and gain insights and data analytics about their own subscribers.

Acquisition: Likewise, brands have the flexibility to create personalized subscription prices, targeting specific discounts to consumers based on their current expenditure on other services. This approach attracts new subscribers by offering tailored pricing that aligns seamlessly with their existing portfolio of services.

In accordance with the invention subscription brands can:
Market and distribute their services cost-effectively to subscribers of other brands.
Implement personalized pricing contingent on individual consumer spending across various services.
Target audiences with personalized prices and trials based on numerous triggers and functions, primarily around pricing, spending, and consumer behaviors.
Provide their own subscribers access to a unique marketplace rewards page with personalized pricing on subscriptions from other brands.
Dynamically offer subscriptions tailored for each unique subscriber.
Serve as the central hub for subscribers' entire digital subscription experience.
Offer comprehensive subscription management tools for all subscriber subscriptions.
Link subscriber discounts on other subscriptions directly to their brand.
Conduct micro-tests for bundles, cross-promotions, pricing strategies, and more before live implementation across their entire brand.
Facilitate global or new market entry by cross-promoting services with locally popular brands.
Cross-promote or “bundle without bundling” without contracts or inflexible pricing and revenue split terms.

Monetize by selling ad space on their unique marketplace rewards page.
Boost promotional efforts by purchasing ad space on other brands' unique marketplace rewards pages.
Control the appearance of and user experience for their own marketplace rewards page with customizations.
Recommend and suppress brands on their rewards marketplace page.

Receive system generated pricing, audience targeting, revenue, and retention optimizations tips.
Integrate seamlessly via API or with Coupon Code
Use machine learning and predictive analytics to provide data analytics and recommendations for revenue optimization, pricing strategy and retention efforts.
Enable community building via partnerships with other brands and referral networks from subscribers.

The platform enables brands to harness the promotional power of their own subscriber base, reducing marketing costs, maximizing subscriber lifetime value, and establishing each brand as the epicenter of its subscribers' digital subscription experience. The ability to offer consumers the right price at the right time, based on their existing spending habits, further distinguishes this innovation.

The foregoing summary, as well as the following detailed description of embodiments of the platform, will be better understood when read in conjunction with the appended drawings of an exemplary embodiment. It should be understood, however, that the invention is not limited to the precise arrangements and instrumentalities shown.

### BRIEF DESCRIPTION OF THE DRAWINGS

FIG. 1 is a flow chart illustrating an example provider flow;

FIG. 2 is a flow chart illustrating how brands can offer their own subscribers personalized offers from other brands;

FIG. 3 is a flow chart illustrating how brands can offer personalized, contingent pricing for their own subscriptions to other consumers on the platform;

FIG. 4 is a flow chart illustrating recommendations and analytics the platform provides to help brands optimize revenues, pricing, and retention;

FIG. 5 is a consumer user flow chart;

FIG. 6 is a flow chart of consumer/subscriber process for purchasing more subscriptions;

FIG. 7 is a block diagram of consumer/subscriber process for managing all of their subscriptions;

FIG. 8 is a flow chart of consumer/subscriber process for porting over existing subscriptions; and

FIG. 9 is a block diagram of integration options.

FIG. 10 is a block diagram of the entire system, its components, and users.

### DETAILED DESCRIPTION OF THE INVENTION

The following description of exemplary embodiments of the invention is not intended to limit the scope of the invention to these exemplary embodiments. The terms “brands” and “providers” are used to describe “Subscription Service Providers” on the platform.

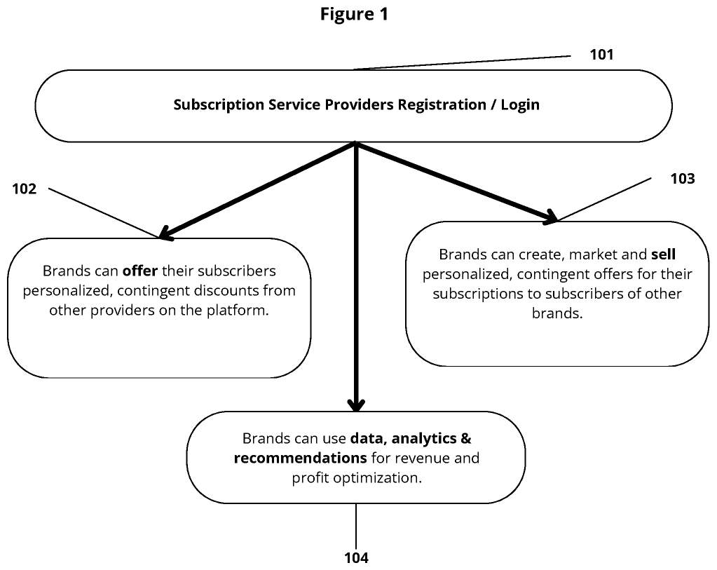

FIG. 1: Illustrated steps that a brand takes to sign up as well as the 3 main high-level items that brands (subscription service providers) can accomplish on the platform.

Step one (101): Providers join the platform through a login/registration screen where they can enter their email/user id and brand name to create an account. Once they have an account, they can set up their brand profile, upload brand images, answer questions about their subscription business that will later be used to help recommend pricing, revenue, and retention strategies, set up their integration options, provide user access links and upload or describe any additional promotional materials to be used for their brand to promote their subscriptions and/or their marketplace rewards page.

Step 2 (102): Brands can create their own marketplace rewards pages with a unique url where they offer their own subscribers access to personalized discounts from all the other brands on the platform. Brands subscribers can register and login to this unique, white-labeled page and buy subscriptions from other brands at offers tailored just to them based on how much they are already verified to be spending on other subscription services. When a subscriber logs into the platform from one of their existing brands, that brand (and the plan they have with that brand) become the plans Primary Brand and Primary Plan on the platform. Purchases, and their discounts, made by subscribers on this page are all tied directly to that brand's account. Canceling the primary brand can result in loss of discounts or service to purchases made on that page. These pages function as loyalty rewards where brands are offering these personalized offers from other providers, with prices determined by how much each consumer is spending on other services, as a reward for being a loyal subscriber.

Step 3 (103): Brands can create personalized, contingent pricing for their subscriptions and offer them to targeted audiences based on how much each consumer already spends on other services. These offers are dynamically shown to consumers on the marketplace rewards pages of other brands on the platform. This creates free marketing and distribution of the brands plans with contingent, personalized pricing to maximize revenues from every subscriber, selling at the highest value point to every subscriber, never underselling a subscription and never missing out on an additional revenue stream. Brands can create several plans with unique pricing and target them to individuals based primarily on how much they are already spending on other subscriptions.

Step 4 (104): Brands can use data, analytics & recommendations for revenue optimization, better profit margins, lower acquisition costs, more subscribers, increased lifetime value and better consumer experience.

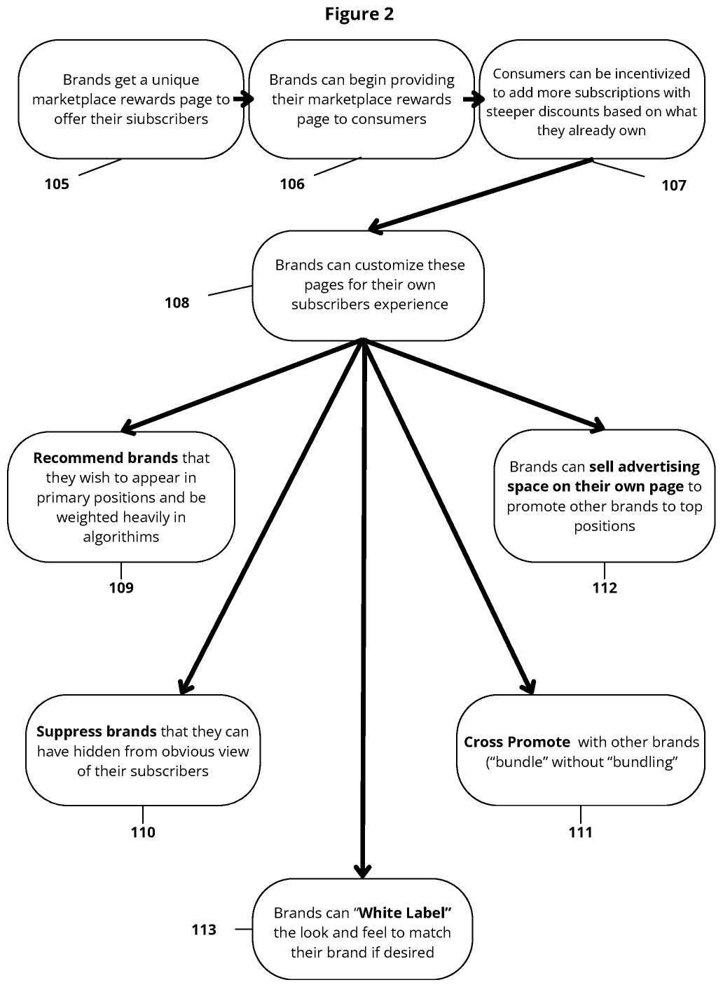

FIG. 2 (Detailed flow for 102): Illustrated steps to show how brands provide their subscribers with personalized, contingent offers from other providers.

Step 1 (105): Brands are provided a unique url (mobile or web app based) where they can offer their own subscribers personalized, contingent pricing and trial offers to other brands subscriptions. These pages are filled with offers from other brands on the platform and are dynamically served to each consumer based on that consumer's basket of verified subscriptions.

Step 2 (106): Base marketplace rewards pages are created when a brand signs up and begins entering their brand details and logos. Brands can offer their subscribers access to these links via web/mobile app links, newsletters, emails, or any other means by which they communicate with their subscribers.

Step 3 (107): Offers are dynamically shown to each subscriber. The best price for each brands' subscriptions appears based on how much that subscriber is already spending on other services. Brands can encourage and incentivize consumers to add their service to their existing subscription portfolio by offering prices that make sense given their current subscription spending.

Step 4 (108): Brands can customize these pages to create a branded experience for their subscribers. They can add brand details and images as well as customize the presentation of other brands for purchase on their marketplace rewards page. Some customization examples are explained further in steps 109-113.

Step 5 (109): Brands can recommend other brands that they wish to appear in top positions on their marketplace rewards page and be weighted heavily in algorithms that decide which subscriptions to offer to their subscribers.

Step 6 (110): Brands can suppress other brands on their marketplace rewards page that they would like hidden from the obvious view of their subscribers. These brands will not get prime real estate and will be harder for their subscribers to find. Similarly, these brands can get a low rating when the platform decides what brands to promote to consumers first when they are looking for similar services.

Step 7 (111): Brands can cross promote with other brands or “bundle” without “bundling”. Cross promotions can appear front and center on each brand's marketplace rewards plage. Brands can encourage their subscribers to review their cross-promotions for special deals and each brand can be selling their partners subscriptions as add-ons to what they already own. Cross-promoted brands also enjoy the highest algorithmic ranking on the platform and will be promoted first to subscribers looking to purchase similar services. Cross promotions are simple to effect—one brand requests another to cross promote and when accepted, both brands get “cross promotional” status on the others marketplace rewards page. The best offers can still be dynamically shown to every consumer. Requests and accepts are simple one-click transactions and the acceptance of both triggers the promotional process to occur on each brand's marketplace rewards page.

Step 8 (112): Brands can list and sell advertising space on their own marketplace rewards page to promote other brands to top positions. Promoted brands can get top positioning to subscribers as well. Brands can control who they sell promotional space to.

Step 9 (113): Brands can “White Label” the look and feel to match their brand if desired.

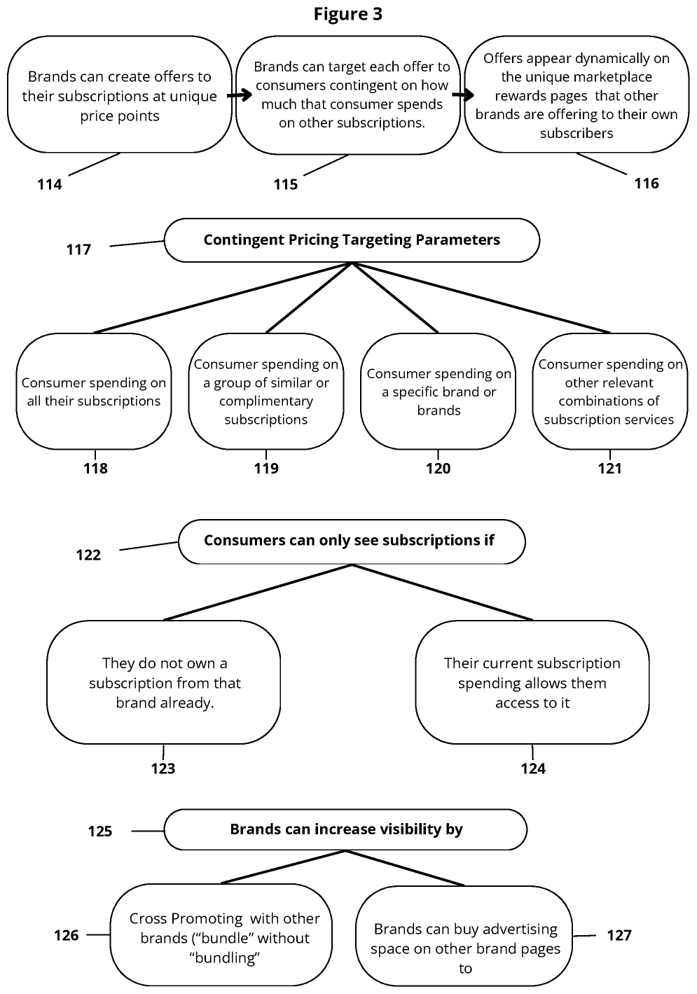

FIG. 3 (Detailed flow for 103): Illustrated steps to show how brands sell personalized, contingent offers to subscribers of other brands.

Step 1 (114): Brands create offers at different prices for their existing subscriptions (offers can include reduced pricing, free trials, low-cost trials, discounts . . . ). Brands can create as many offers as they like.

Step 2 (115): Each offer can be targeted towards different consumers based on how much they are already spending on other services. The system recognizes the verified spending of each consumer and serves the right offer to the right consumer based on the brands settings for the offer and the consumer's current basket of verified subscriptions. Triggers, machine learning and algorithms can help to automate this process.

Step 3 (116): These offers appear dynamically to subscribers of other brands when they view their primary brands marketplace rewards page.

Step 4 (117): Brands can offer unique pricing to consumers based on how much they already spend on different baskets of subscriptions. Brands can create plans targeted to consumers that spend <, =, or <, “x” amount of dollars on specific baskets of subscriptions. (See steps 118-121).

Step 5 (118): Brands can target offers to consumers spending <, <=, >, >=, =, “x” amount of dollars on all of their existing verified subscriptions.

Step 6 (119): Brands can target offers to consumers spending <, <=, >, >=, =, “x” amount of dollars on all of their existing verified subscriptions on similar, complimentary, or other category based groupings of subscription services.

Step 7 (120): Brands can target offers to consumers spending <, <=, >, >=, =, “x” amount of dollars on all of their existing verified subscriptions on a specific brand or brands.

Step 8 (121): Brands can target offers to consumers spending <, <=, >, >=, =, “x” amount of dollars on any combination of criteria accessible via the platform.

Step 9 (122): The best targeted offers for each brands plan can appear to consumers upon the offers passing 2 preliminary qualifications.

Step 10 (123): The first qualification from Step 9, Item 122 is: Brands can restrict access to the offer if the consumer already has a verified higher priced subscription from that brand.

Step 11 (124): The second qualification from Step 9, Item 122 is: Brands can restrict access to the offer if the consumer is not within the subscription spending limits identified for that offer (the consumer does not satisfy the contingent pricing conditions set by the brand for the offer).

Step 12 (125): Brands plans typically appear on the marketplace rewards pages of all other brands on the platform. To increase visibility across these pages both in terms of brand placement on the pages as well as to receive higher algorithmic promotions to subscribers that visit these pages, brands can both Cross Promote with other brands and buy sponsored advertising space on the pages of other brands.

Step 13 (126): Cross Promoting or “bundle” without “bundling”, allows brands to suggest partnerships whereby each brand cross promotes the other services to their own subscribers at special prices. In these cases, brands can still offer multiple pricing offers to these subscribers based on other subscriptions in each consumers basket of services as well. When brands elect to cross promote, they appear as such on each brand's marketplace rewards page and get higher ranking in algorithms promoting these services to their own subscribers. Cross promotions can be canceled at any time by either party. Cross promotions are requested by one party and accepted by the other with one click each.

Step 14 (127): Sponsored ads: Brands can buy advertising space on the marketplace rewards pages of other brands if these offers are available to them. Brands that buy sponsored space on other brands marketplace rewards pages get top placements and high rankings in algorithms used to serve options to consumers. Sponsored ads can be labeled accordingly to consumers. Each brand can review the sponsorships available to them and choose to purchase them via their provider dashboard. Payments are processed through the platform and the sponsored promotion can appear immediately.

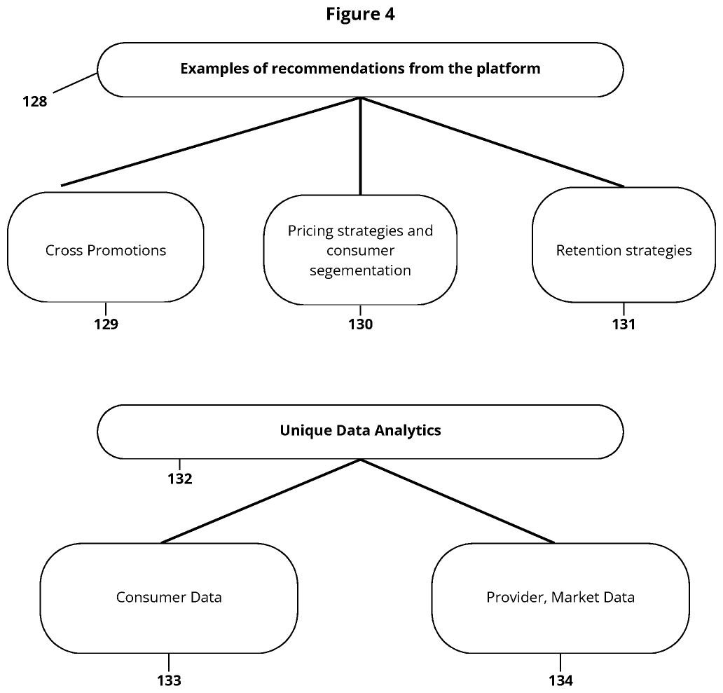

FIG. 4 (Detailed flow for 104): Illustrated steps to show how brands are provided with data, analytics, and recommendations to optimize profitability.

Step 1 (128): Brands are provided with unique reports that can give information collected from user actions on the site. The data includes first data information gathered from subscriber and provider behaviors and transactions on the platform. These reports and data points can be combined with AI, machine learning, automation tools and algorithms to produce important pricing, revenue, retention, subscriber acquisition and profit optimization tips that brands can initiate with one click.

Step 2 (129): A first example of how the platform provides revenue optimization strategies (referencing Item 128): Brands are recommended specific cross promotional opportunities with other brands. Recommendations can be adjusted based on new intelligence gathered on the platform using AI, machine learning and human intervention to help serve up the best options.

Step 3 (130): A second example of how the platform provides revenue optimization strategies (referencing Item 128): Brands are recommended to publish specific offers for their subscriptions to specific targeted audiences to increase profitability, subscribers, and lifetime value. Recommendations can be adjusted based on new intelligence gathered on the platform using AI, machine learning and human intervention to help serve up the best options.

Step 4 (131): A third example of how the platform provides revenue optimization strategies (referencing Item 128): Brands are recommended customization options for their Marketplace Rewards page to boost user experience, transactions, and retention. These can be ways to optimize provided settings on the platform (cross promotions, sponsored ads, recommendations, and suppressions, and more) or off platform actions such as text, email, or social campaign promotions. Recommendations can be adjusted based on new intelligence gathered on the platform using AI, machine learning and human intervention to help serve up the best options.

Step 5 (132): There are numerous unique data points that the platform uncovers for brands. Below are 2 examples.

Step 6 (133): The platform can reveal what a brands subscribers are interested in, where they spend their money on other subscriptions, how they value one brand vs another and any other consumer related trends, observations, and insights gained through normal platform usage.

Step 7 (134): The platform can uncover trends, pricing strategies, and competitor insights to help brands navigate the ever-changing landscape.

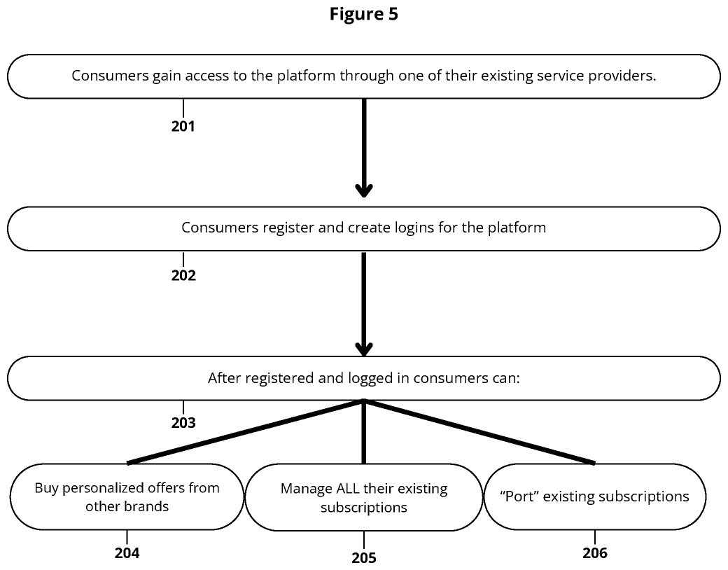

FIG. 5: Illustrated the steps that a brands subscriber (also referenced here as a consumer) takes to sign up and take actions on the platform.

Step 1 (201): Subscribers to brands with accounts on the platform can receive access to the platform from that brand. Consumers that have multiple subscriptions from brands on the platform can choose one of these brands to access the platform through. This brand can become the consumers “Primary” provider. Consumers can access the platform anywhere their provider offers them (i.e. emails, web/app links, login forms, etc.). Consumers gain access to their Primary Providers marketplace rewards page when they join using that brands' unique access links or other verified entrance methods.

Step 2 (202): Upon first registering, consumers answer questions about their favorite subscriptions, telling us about existing subscriptions they already have and about the kinds of subscriptions they are most interested in receiving offers from.

Step 3 (203): Consumers can accomplish 3 main objectives after accessing the platform via their primary provider.

Step 4 (204): (Referencing 203) Consumers can buy personalized offers (with contingent pricing) from other brands on the platform.

Step 5 (205): (Referencing 203) Consumers can manage all their existing subscriptions.

Step 6 (206): (Referencing 203) Consumers can port existing subscriptions over to their account.

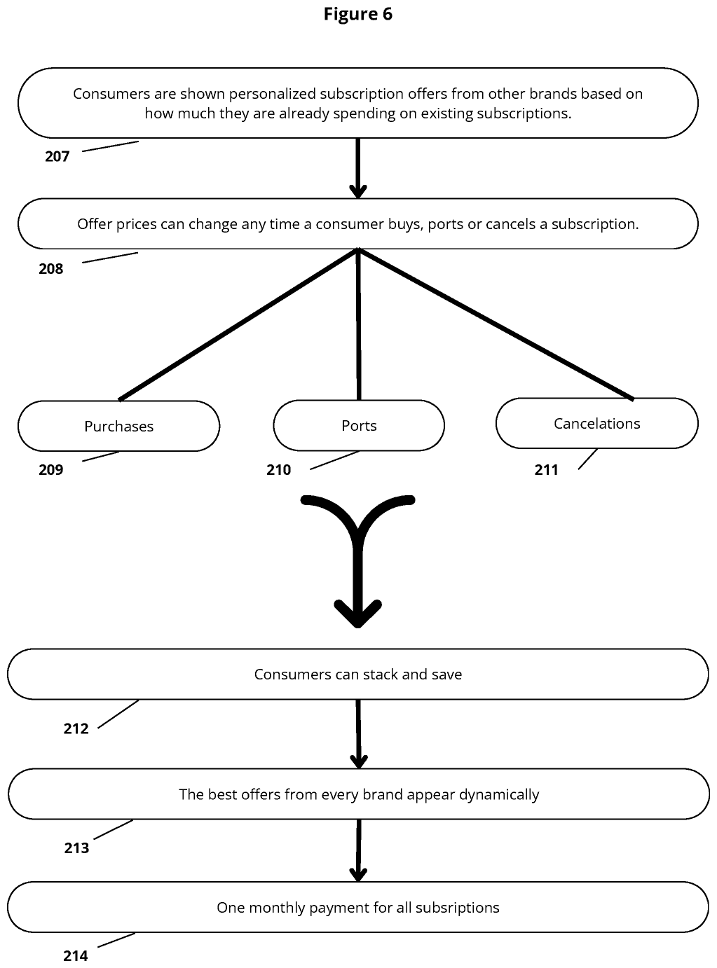

FIG. 6 (Detailed flow for 204): Illustrated steps to show how consumers can review and purchase personalized offers from their primary brands marketplace rewards page.

Step 1 (207): Consumers are shown personalized offers from other brands based on how much they are already spending on existing subscriptions purchased or verified on the platform. Primary plans from the primary provider, ported subscriptions, and subscriptions purchased on the platform are all forms of verified spending on existing subscriptions. Certain consumer behaviors and information provided via the platform can also affect offers.

Step 2 (208): Pricing is dynamic to each consumer and can change any time a consumer buys, ports, or cancels a subscription on the platform. All actions affect the consumers' total verified spending which in turn, could result in new pricing from brands.

Step 3 (209): Purchases: Are made directly on the platform and discounts are tied directly to the consumer's Primary account. Purchases increase the consumers verified spending and recalculates offers from other brands based on their totals.

Step 4 (210): Ports: Consumers can add existing subscriptions to their account to increase their verified spending. Consumers can port existing subscriptions to A) Increase their verified spending and get better deals from other providers on the platform B) Easily manage their subscription in the same place as their other subscriptions. Porting subscriptions increases the consumers verified spending and recalculates offers from other brands based on their totals.

Step 5 (211): Cancelations: Consumers can easily cancel any subscription they buy or port into their account without penalty. Cancelling a primary plan, however, can result in a cancelation fee, loss of discounts, cancelled services or other penalties. Canceling any subscription can decrease the consumers verified spending and recalculates offers from other brands based on their totals.

Step 6 (212): Consumers making purchases via the platform can stack and save on subscriptions, allowing them to purchase all the subscriptions they love at prices that make sense.

Step 7 (213): Only the best offer for each brand's subscriptions appears dynamically to each consumer based on the parameters set by the brand and the verified spending of the consumer.

Step 8 (214): Consumers can pay for all their purchased subscriptions with one payment charge once monthly via the platform.

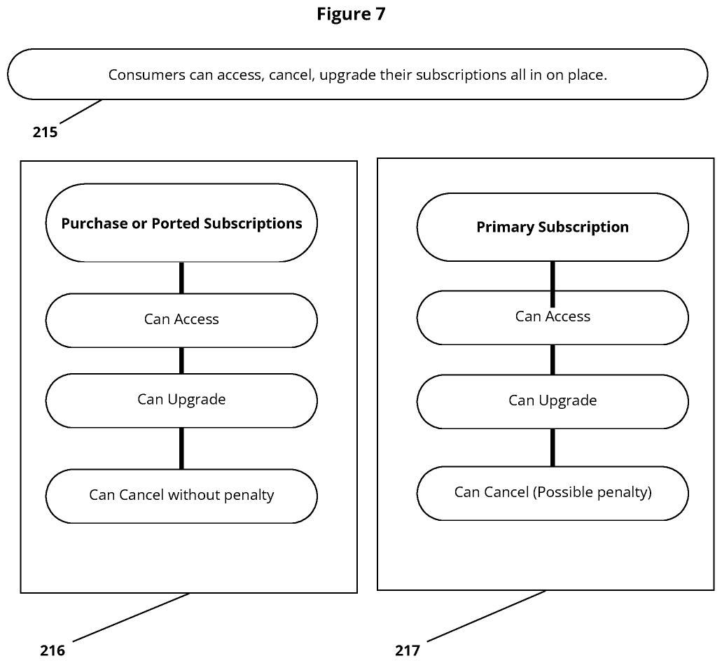

FIG. 7 (Detailed flow for 205): Illustrated steps to show how consumers can manage all their subscriptions.

Step 1 (215): Consumers use a subscription management portal that allows them to access, cancel, upgrade, and review all their subscriptions.

Step 2 (216): For subscriptions purchased on the platform or ported to it, consumers can access, upgrade, review and easily cancel their subscriptions at any time. These actions can be taken, including cancelations, without penalty. Cancelations and upgrades to these subscriptions will alter the verified spending amount, which could affect the value of the deals they are being offered from other brands.

Step 3 (217): Primary Subscriptions can be accessed, upgraded, reviewed, and canceled either on the platform or from the provider directly. Canceling a primary plan can result in penalties in certain situations that could include cancelation fees or loss of service or discounts to plans purchased on the platform. If Primary Plans are cancelled and the user wants to remain a user of the platform, they can select a new primary provider. Cancelations and upgrades to these subscriptions will alter the verified spending amount, which could affect the value of the deals they are being offered from other brands.

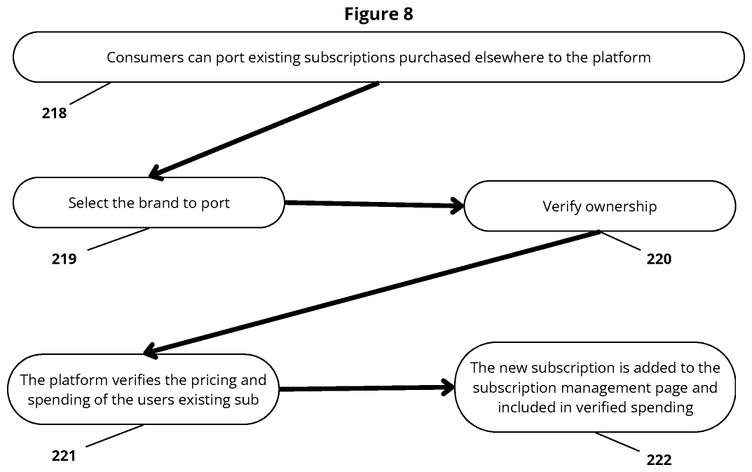

FIG. 8 (Detailed flow for 206): Illustrated steps to show how consumers can port existing subscriptions to the platform.

Step 1 (218): Consumers can port existing subscriptions from other brands on the platform to increase verified spending (get better deals) and manage their existing subs all in one place.

Step 2 (219): Consumers can select from a list of brands they wish to add to their account. Brands listed have a connected API that allows the platform to verify subscription status, subscription name, subscription price, subscription term and other necessary data points to facilitate the management of account from the platform.

Step 2 (220): Consumers can verify their account information (via an automated process or manual entry).

Step 3 (221): The platform can verify the subscription and imports required plan information creating a link between the platform and the brands database. New transactions are then registered on both systems.

Step 4: (222): The platform can set up a management profile for the ported subscription that appears on the platform and adds the verified spending amount to the consumers total verified spending tally. Consumers can manage the plan accordingly from either the brand or the platform.

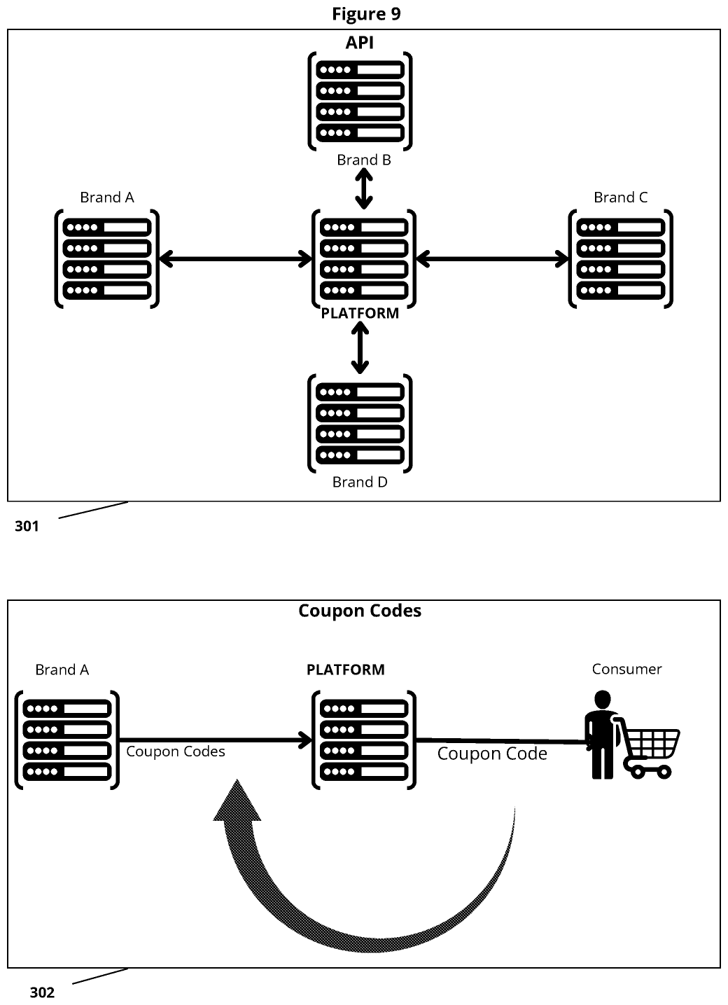

FIG. 9: Illustrated steps to show how brands integrate with the platform.

Step 1 (301): Brands can simply utilize a special API key provided by the platform to access all their transactional data (buys, cancelations, ports) etc. To get better results from the platform, they can also share certain data on their own brands subscribers (i.e. emails and subscription status, price) via the same API. The platform does not need brand data to operate but it is helpful to increase results.

Step 2 (302): Alternatively, brands can provide the platform with coupon codes that allow free lifetime access to their individual plans. When purchases are made, a unique 1-time code is provided to the purchaser to use upon registration for the brands services. Upon cancelation, brands are notified manually of the cancelation and will need to update their records accordingly. Coupon codes, and any additional data about subscribers providers wish to share, can be transferred via excel or csv. And manually uploaded and/or uploaded via an automated batch process.

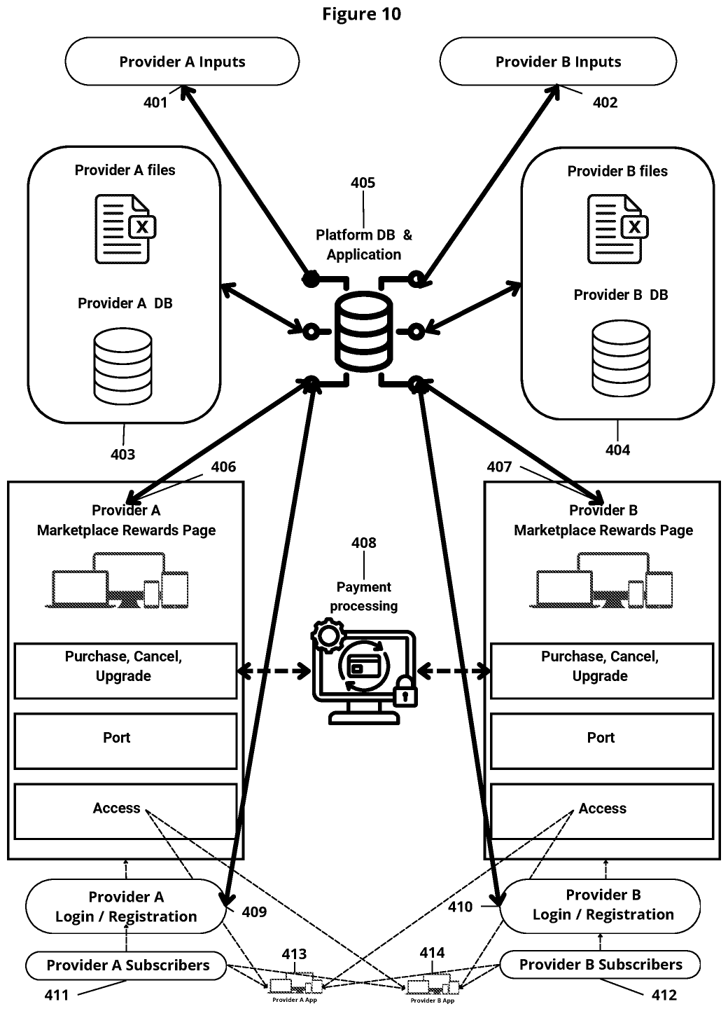

FIG. 10: Illustrated diagram identifying the components, databases, communications, and users for the entire system. While the real-world example could have an infinite number of providers, this example gives an overview of the processes for 2 providers, A and B, along with their subscribers and their interactions with the platform.

Step 1: Manual provider inputs to the platform database. Providers can communicate information to the platform via their login/registration page and their provider dashboard (401, 402) both web-based interfaces. An account can be created, and all inputs stored in the platform database (405). Provider inputs can include information about their brand, the brands they currently sell publicly, offers they create on the platform, audiences they target on the platform, cross promotions, recommendation, suppressions, ad-sales, ad-purchases, and any other information prompted for on their dashboard.

Step 2: Additional communication can be provided from the provider to the platform (405) via API or secure file transfers (403, 404). This data can also be stored in the database. Data communicated this way can include subscriber transactional information, coupon codes, or other information needed to create a clean and seamless process or improve recommendations and automated offering and retention processes.

Step 3: Platform communications to the provider. The platform (405) can provide offer, plan, pricing, audience targeting, marketplace reward page adjustments, promotions, and other revenue optimization recommendations to the provider on their dashboard (401, 402). The platform can use data provided by the provider, transactional data gathered from the platform, machine learning, human adjustments, ai, and algorithms to make recommendations. Transactional information can be communicated from the platform (405) back to the provider via an API directly to their database or with secure files (403, 404) communicated securely. Reports and transactional details can also be made accessible on the provider dashboard (401,402).

Step 4: Communication with the consumer. The platform can create, and the provider can publish the marketplace rewards page (406, 407) and login/registration page (409,410) (both can be app and web interfaces) live on the web. Once published, the brand's subscribers (411, 412) can begin accessing and making purchases, ports, cancelations etc. on their personal, dynamic, marketplace rewards page (406,407). Subscribers (411, 412) login/register (409,410) to access their marketplace rewards page (406, 407), creating a new customer account that is stored in the platform database (405). All payment processing (purchases, cancelations, pro-rating, upgrades, refunds, etc.) is processed by an approved third payment processing provider (408) and payment methods are not stored in the platform database (405). The platform application (405) can review the subscriptions that the consumer owns (primary, purchased on the platform, ported, or otherwise verified) to serve up the best prices for each individual consumer based on their spending habits and the plans available as determined by the provider inputs and automations performed internally. The platform matches consumer data with provider data in the database (405) to present each consumer with the best offer, at the best price, every time on their marketplace rewards pages (406, 407). The offer process can be enhanced with intelligence gathered on the platform using AI, machine learning and human intervention to help serve up the best options.

Step 5: Provider subscribers (411,412) can access their purchased, active, subscriptions directly on the providers apps (413,414) or they can navigate to the providers apps form their marketplace rewards pages (406,407).

1. A collaborative subscription marketplace and loyalty platform system comprising:
a system where brands can sell personalized subscription offers, with contingent pricing, to subscribers of other brands on the platform via unique marketplace rewards pages created individually for each brand;
a system where brands can link their subscribers subscription discounts directly to their brand;
a system and dashboard where subscription service providers can a) create and control a marketplace rewards page where the brands subscribers can purchase personalized offers from other brands, b) create personalized offers with unique prices for consumers based on how much the consumer is already spending on other services, c) sell those personalized, contingent subscription offers dynamically on the platform via marketplace rewards pages of other brands, d) access and implement data and recommendations for optimizing pricing, revenue and retention strategies, and e) review data analytics and implement recommended pricing, audience targeting, cross promotion, advertising, and retention strategies;
a system and dashboard where consumers can a) purchase personalized offers tailored specific for them based on how much they spend already on other subscription services b) manage all their subscriptions in one place c) port existing subscriptions onto the platform for management and verified spending purposes.

2. The system of claim 1, further comprising a brand owned subscription marketplace where each brand creates their own, customizable subscription marketing and advertising experience to share directly with their own subscribers.

3. The system of claim 2, further comprising the ability for brands to optionally customize this experience with methods for: recommending brands to appear in prime positions on the page and to rank higher in algorithms that serve subscriptions to brands subscribers; suppressing other brands causing them to appear in non-prime positions on the page and to rank lower in algorithms that serve subscriptions to the brands subscribers where suppression requires subscribers to search more specifically for the suppressed brand.

4. The system of claim 2, further comprising the ability to customize this experience with a method for cross promotions where: cross-promoting brands can cause each other's subscriptions to appear in prime positions on each other marketplace rewards pages and to rank higher in algorithms that serve subscriptions to the brands subscribers;
cross-promoting partners can still offer their cross-promotions dynamically to each individual consumer, with contingent pricing based on each consumer's entire portfolio of verified subscriptions;
the platform can identify and recommend specific cross promotions to brands for revenue, retention, and profitability maximization purposes; brands can enter into cross promotions with a single click to request and a single click to accept; brands can exit cross promotions with a single click;
the platform can recommend off-platform cross promotional marketing collateral and campaigns to drive traffic to the cross-promotions existing on each brands subscription marketplace rewards page.

5. The system of claim 2, further comprising the ability to customize this experience by selling sponsored ads entitling the purchasing brands subscription offers to appear in premium positions on the selling brands marketplace rewards page and obtain higher ranking in algorithms used to show offers to consumers visiting the page with further methods to: allow brands to dictate the cost and term for sponsorships they offer;
allow brands to target each sponsorship opportunity to brands they deem acceptable to receive the offer and have appear on their marketplace rewards page; allow brands to target each sponsorship opportunity to brands based on characteristics such as annual brand revenue, subscription category, specific brand names excluded/included, and specific sub-categories, etc.

6. The system of claim 2, further comprising the ability for brands to customize their marketplace rewards pages with brand logos, hero images, brand messaging and other customizable features.

7. The system of claim 2, further comprising the ability for brands to tie all discounts from purchases on a brands marketplace rewards page directly to that primary brand with further methods that: allow brands the ability to penalize primary brand cancelations with cancelations fees and/or loss of services or loss of discounts to purchases made from their marketplace rewards page.

8. The system of claim 2, further comprising the ability to offer total subscription management tools to their subscribers as a thank you for being a loyal member of that brand with methods for: subscribers to port existing subscriptions onto the platform for the purposes of managing that subscription and for adding the amount being paid for that subscription to the consumers total verified spending numbers;
subscriber to cancel without penalty any subscription purchased on or ported to the platform;
subscribers to cancel, potentially with a penalty, the primary subscription used to join the platform either from the platform or directly from the provider; and
the ability to access, upgrade or review their primary, ported, and purchased subscriptions.

9. The system of claim 1, further comprising a brand owned subscription marketplace where each brand creates their own, customizable subscription offers with contingent pricing based on how much consumers are spending on other services and sell them dynamically to subscribers of other brands.

10. The system of claim 9, further comprising methods by which: brands can create an infinite number of offers to their existing subscriptions at various prices; brands can target these personalized offers to consumers based on how much they are spending on other services;
brands can target personalized offers to consumers based on how much they are spending on a) all of their subscriptions b) how much they are spending on similar or complimentary services c) how much they are spending on any specific brand or brands d) how much they are spending on any specific subscription category or e) how much they are spending on other classifications of subscriptions as collected on the platform.

11. The system of claim 9, further comprising a method by which verified spending is collected by identifying the active recurring payments made on a consumer's primary plan, ported plans and plans purchased on the platform.

12. The system of claim 9, further comprising methods by which: brands can sell these customizable offers dynamically to subscribers of other brands directly on each brands marketplace rewards page;
brands can use the platform to automate the adjustment of pricing based on triggers related to pricing, spending, and consumer behaviors; brands can further target consumers to individual offers based also on consumer behavior identified on the platform.

13. The system of claim 9, further comprising the ability for brands to restrict viewing of each offer to consumers that a) do not already own any or a higher value subscription from their own brand and b) satisfy the spending requirements attached to that offer.

14. The system of claim 9, further comprising the ability for brands to include free or limited trial periods instead of or in addition to discounted subscription prices and/or discounted after trial subscription prices.

15. The system of claim 9, further comprising the ability for brands to micro-test new partnerships, bundles, pricing, and other strategies on the platform to segmented audiences before rolling out the best option live, across their entire brand.

16. The system of claim 9, further comprising the ability for brands to easily enter new markets, foreign and domestic, through cross promotions with locally popular subscription services.

17. The system of claim 9, further comprising methods where consumers can: limit their number of credit card payments by combining payments on the platform, potentially combining them all into one monthly payment; stack and save with brands incentivizing consumers with discounts to encourage them to add their services to their existing subscription portfolio; continuously add to and not replace their existing subscriptions.

18. The system of claim 9, further comprising the method for consumers to download apps to their phones or elsewhere directly without using app stores.

19. The system of claim 1, further comprising a brand owned subscription marketplace where each brand gets access to unique, real-time, first party consumer, competitor and market data analytics and specific revenue, pricing, and retention optimization recommendations.

20. The system of claim 19, further comprising reporting for brands showing: what their brands existing subscribers' interests are based on what they are actively spending money on, canceling, viewing, researching and more; where new subscribers are coming from (i.e. streaming music, streaming audio, wellness, gaming, news and media, dating . . . );
how their cross promotions are performing; how their paid ads (purchased and sold) are performing; how their offers and segmentations are performing; off-platform marketing campaigns and collaboration recommendations to increase success on the platform; and
how they compare to other brands on the platform.
